(19) United States
(12) Patent Application Publication
(10) Pub. No.: US 2021/0041720 A1
(43) Pub. Date: Feb. 11, 2021

(54) Armless Eyeglasses

(71) Applicants: Pragnesh Ashar, East Brunswick, NJ (US); Kush Ashar, East Brunswick, NJ (US)

(72) Inventors: Pragnesh Ashar, East Brunswick, NJ (US); Kush Ashar, East Brunswick, NJ (US)

(21) Appl. No.: 16/714,368

(22) Filed: Dec. 13, 2019

Related U.S. Application Data
(60) Provisional application No. 62/884,149, filed on Aug. 7, 2019.

(51) Int. Cl. G02C 5/12

(52) U.S. Cl. CPC G02C 5/128

(57) ABSTRACT

The present disclosure pertains to an eyewear apparatus capable of allowing a wearer to provide useful information to a hairdresser. The apparatus comprises at least one visual device configured to provide vision to the wearer. During operation, the apparatus is configured to be disposed on the wearer such that the disposal of the apparatus causes no hindrance to the hairdresser. The apparatus causes no hindrance to the hairdresser, by means of having no support arms that are capable of providing hindrance on the person of the wearer where the hairdresser is conducting his given work functions, during operation. In an application, the apparatus includes a maximum of two visual devices, the first visual device, and a second visual device. The visual devices include lenses or glasses or other mechanism directed towards near-sightedness, or far-sightedness.

### CROSS REFERENCE TO RELATED APPLICATIONS

This application claims the benefit of the provisional application with the Ser. No. 62/884,149 filed on Aug. 7, 2019, the entirety of which is incorporated herein by reference.

### TECHNICAL FIELD

The present disclosure generally relates to eyewear or spectacles or eyeglasses, that are efficient. More particularly, the present disclosure relates to spectacles or eyeglasses or eye-wears that simultaneously rest on a wearer's nose and do not include side arms or temples.

### BACKGROUND

Background description includes information that can be useful in understanding the present invention. It is not an admission that any of the information provided herein is prior art or relevant to the presently claimed invention, or that any publication specifically or implicitly referenced is prior art.

Getting a haircut can be a stressful experience for people who cannot view distant objects clearly. If the haircut goes wrong and a person is near-sighted, he or she may be unable to see their hair in order to provide instructions to correct or modify to the hairdresser. Particularly, people without contacts or otherwise people who fail to wear contacts may be unable to see how their hair is getting cut. Accurate feedback may not be provided to the barber or hairdresser.

In current solutions existing to the problem, some are directed to mirrors that may be handheld by the hairdresser who would be then provide their own version of feedback or comments to the client, or otherwise the handheld mirror itself may not be an accurate way for the client to modify the style at issue. Some other solutions are directed to the hairdresser or barber being the individual who provides comments based on his own perception of the style. These cases have deficiencies, the most particular and crucial of which being that of the client being unable to have control over his/her feedback or otherwise being unable to provide feedback or comments that may be built around the client's own style, and which indeed may only be known to the client's self.

With Armless Eyeglasses, the wearer's eyeglasses can still remain on his or her face while getting a haircut or coloring the hair to ensure the styling is complete to the client's satisfaction without the arm getting in the way.

Therefore, there is a need in the art to provide a reliable, efficient, and accurate device and method that can allow the provision of feedback regarding style to a target capable of effecting the style on a given subject.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities or dimensions of items, and so forth, used to describe and claim certain embodiments of the invention are to be understood as being modified in some instances by the term “about.” Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

### Objects of the Present Disclosure

Some of the objects of the present disclosure, which at least one embodiment herein satisfies are as listed herein below.

It is another object of the present disclosure to provide a simple and cost effective an eyewear apparatus capable of allowing a wearer to provide useful information to a hairdresser.

It is another object of the present disclosure to provide a reliable, efficient, and accurate an eyewear apparatus capable of allowing a wearer to provide useful information to a hairdresser.

It is another object of the present disclosure to provide a robust eyewear apparatus capable of allowing a wearer to provide useful information to a hairdresser.

### SUMMARY

The present disclosure generally relates to eyewear or spectacles or eyeglasses, that are efficient. More particularly, the present disclosure relates to spectacles or eyeglasses or eye-wears that simultaneously rest on a wearer's nose and do not include side arms or temples.

This summary is provided to introduce simplified concepts of a system for time bound availability check of an entity, which are further described below in the detailed description. This summary is not intended to identify key or essential features of the claimed subject matter, nor is it intended for use in determining/limiting the scope of the claimed subject matter.

An aspect of the present disclosure pertains to an eyewear apparatus capable of allowing a wearer to provide useful information to a hairdresser. The apparatus comprises at least one visual device configured to provide vision to the wearer.

In an aspect, during operation, the apparatus is configured to be disposed on the wearer such that the disposal of the apparatus causes no hindrance to the hairdresser.

In an aspect, the apparatus causes no hindrance to the hairdresser, by means of having no support arms that are capable of providing hindrance on the person of the wearer where the hairdresser conducts given work functions, during operation.

In an aspect, the apparatus includes a maximum of two visual devices, namely the first visual device pertaining to the first of the at least one visual device, and a second visual device.

In an aspect, the apparatus further comprises a nose bridge that connects the first visual device and a second visual device, and a nose pad assembly configured to provide a placement mechanism for the apparatus.

In an aspect, the visual devices include lenses, glasses or other mechanism directed towards near-sightedness, or far-sightedness.

In an application, wherein the apparatus is unisex.

In an application, wherein the apparatus is of a universal size construction.

Various objects, features, aspects and advantages of the inventive subject matter will become more apparent from the following detailed description of preferred embodiments, along with the accompanying drawing figures in which like numerals represent like components

### BRIEF DESCRIPTION OF THE DRAWINGS

The diagrams are for illustration only, which thus is not a limitation of the present disclosure, and wherein:

FIG. 1 shows a front perspective view of an exemplary apparatus capable of allowing a wearer to provide useful information to a hairdresser, in accordance with an embodiment of the present disclosure.

FIG. 2 shows a generally and partially isometric view of an exemplary apparatus capable of allowing a wearer to provide useful information to a hairdresser with the figure indicating an additional exploded view with regards to a visual device associated with the exemplary apparatus, in accordance with an embodiment of the present disclosure.

FIGS. 3A-3C shows various applications of an exemplary apparatus capable of allowing a wearer to provide useful information to a hairdresser with particular emphasis on its operation, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments. On the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

Embodiments of the present invention may include various steps, which may be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware and/or by human operators.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein. Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases, it will be recognized that references to the “invention” will refer to subject matter recited in one or more, but not necessarily all, of the claims.

Various terms as used herein are shown below. To the extent a term used in a claim is not defined below, it should be given the broadest definition persons in the pertinent art have given that term as reflected in printed publications and issued patents at the time of filing.

The present disclosure generally relates to eyewear or spectacles or eyeglasses, that are efficient. More particularly, the present disclosure relates to spectacles or eyeglasses or eye-wears that simultaneously rest on a wearer's nose and do not include side arms or temples.

An aspect of the present disclosure pertains to an eyewear apparatus capable of allowing a wearer to provide useful information to a hairdresser. The apparatus comprises at least one visual device configured to provide vision to the wearer.

In an aspect, during operation, the apparatus is configured to be disposed on the wearer such that the disposal of the apparatus causes no hindrance to the hairdresser.

In an aspect, the apparatus causes no hindrance to the hairdresser, by means of having no support arms that are capable of providing hindrance on the person of the wearer where the hairdresser conducts given work functions, during operation.

In an aspect, the apparatus includes a maximum of two visual devices, namely the first visual device pertaining to the first of the at least one visual device, and a second visual device.

In an aspect, the apparatus further comprises a nose bridge that connects the first visual device and a second visual device, and a nose pad assembly configured to provide a placement mechanism for the apparatus.

In an aspect, the visual devices include lenses, glasses or other mechanism directed towards near-sightedness, or far-sightedness.

In an application, wherein the apparatus is unisex.

In an application, wherein the apparatus is of a universal size construction.

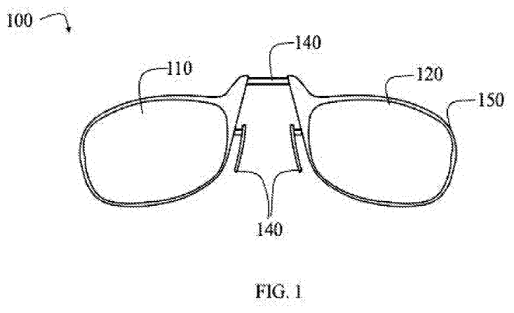

FIG. 1 shows a front perspective view of an exemplary eyewear apparatus 100 capable of allowing a wearer to provide useful information to a hairdresser, in accordance with an embodiment of the present disclosure.

The eyewear apparatus 100 includes a first visual device 110, a second visual device 120, a nose bridge 130, and a nose pad assembly 140. The visual device 110, 120 are devices that allow a user vision with regards to particular usages in accordance with the present disclosure. In other words, the visual device 110, 120, with regards to their namesake function afford visual functions to users utilizing them either by wearing them or otherwise by holding the visual devices 110, 120 to merely just utilize the function. The visual devices 110, 120 are mounted on a mounting member 150 which is typically a rim that affords and allows the visual devices 110, 120 to be placed on them, and in some embodiments, be fixed on them. The visual devices 110, 120 are typically rectangular in shape as shown in FIG. 1 but can also include other shapes.

One main function of the visual devices 110, 120 is that of its ability to provide vision as already mentioned. The devices 110, 120 affords this by means of a lens or lenses that has near-sightedness properties. In other words, a user wearing the apparatus 100 is typically near-sighted and therefore the corresponding lenses allow a wearer (i.e. the user) to see clearly a target object or a subject. In other embodiments, the visual devices 110, 120 can also correspond to far-sightedness or other optical matter that may be appreciated by a person skilled in the art.

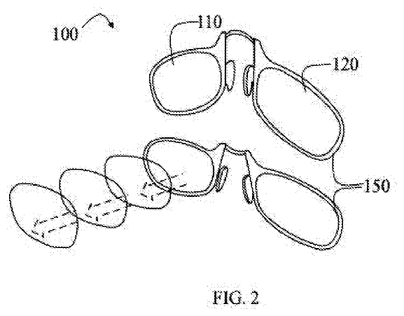

FIG. 2 shows a generally and partially isometric view of the exemplary apparatus 100 capable of allowing a wearer to provide useful information to a hairdresser with the figure indicating an additional exploded view with regards to one of the visual devices 110, 120 associated with the exemplary apparatus 100, in accordance with an embodiment of the present disclosure. In particular, the visual device 110 is shown as being separate from the device mount 150 with the visual device 120, on the contrary being intact.

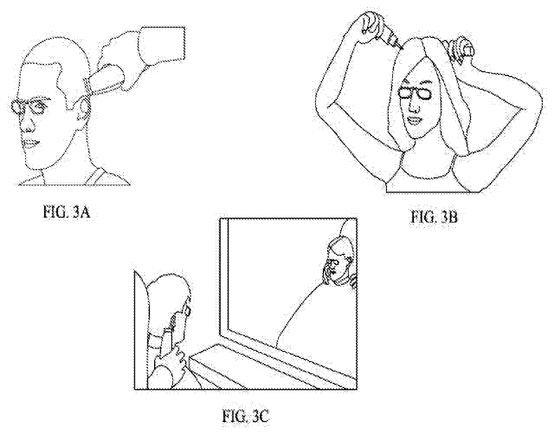

Referring again to FIG. 1, the nose bridge 130 connects the first visual device 110 and the second visual device 120. During operation, the nose bridge 130 also fits over a nose top of a wearer as can been seen in FIGS. 3A-3C. The nose pad assembly 140 provides a placement mechanism for the apparatus 100 as shown in FIG. 1 by allowing the apparatus 100 to be placed over the stem of the nose of a wearer which is again clearly shown in FIGS. 3A-3C.

As can further be appreciated from FIGS. 3A-3C, the apparatus 100 is armless in that the apparatus lacks arms 100 such that during operation, a corresponding portion of the wearer is naked as to any external objects such that a hairdresser can attend to that portion of the wearer. In a typical, the wearer wears the apparatus 100 which has no arms that typically connect to the ears and rest in a stationary position. In that position, the arm is disposed along the portion of the person of the wearer where there is hair, i.e. the portion where the hairdresser conducts given work functions. In other words, the apparatus 100 causes no hindrance to the hairdresser, by means of having no support arms that are capable of providing hindrance on the person of the wearer where the hairdresser is conducting his given work functions, during operation.

FIGS. 3A-3C also show various applications pertaining to the present disclosure. For example, FIG. 3A, in part, shows a hairdresser working on a portion of the person of the wearer where an arm would otherwise be present in an eyewear having an arm. FIG. 3B shows, in part, a wearer using the apparatus 100 while attempting to work over a portion of the person of the wearer where an arm would otherwise be present in an eyewear having an arm. FIG. 3C shows, in part, a wearer poised to provide comments based on the hairdresser's work over a portion of the person of the wearer where an arm would otherwise be present in an eyewear having an arm.

The present invention relates to eyeglasses. More particularly, the present invention relates to Armless Eyeglasses. The Armless Eyeglasses provides near-sighted glasses wearers with an alternative pair of eyeglasses capable of staying on the nose bridge without the side arms and enables haircut and styling clients to keep their glasses on without interfering with the haircut. The present invention remains secure on the nose bridge, ensuring the eyeglasses do not fall off during the haircut, styling, or coloring and prevents a haircut from going awry and a client receiving a haircut he or she is not happy with. The Armless Eyeglasses allows users to interchange lenses within the frame to accommodate different situations. The user can also use the glasses while hair dyeing which could be in the user's home or any other place the user may deem fit.

The concept of fitting these glasses with negative powers is unique utility wise because generally armless glasses are fitted only with positive powers which are used for reading purposes. With this product though there will be powers with negative numbers like −1, −1.5, −2, −2.5 etc.

These glasses can also be made via prescription by a doctor, optician or an ophthalmologist. These glasses will also benefit the user while combing their hair.

The disclosure in this paragraph is generic, but nevertheless pertains and is related to the present disclosure, and therefore may be repetitive with regards to the above. Armless Eyeglasses is a pair of improved glasses for near-sighted individuals. The glasses rest on the nose bridge and do not feature the standard arms that sit on the ears and temple. Without the arms, the wearer can maintain his/her glasses while getting a haircut. The eyeglasses are intended to be non-prescription so that people can purchase the glasses without visiting a doctor. The near-sighted individual can maintain clear vision and give feedback to the barber and stylist to prevent unwanted haircuts and/or mistakes. Furthermore, the glasses can be especially helpful while coloring hair. Users are able to maintain proper vision and ensure hair is colored to a desired tint or tone. Each pair of glasses can be unisex with a one-size-fits-all construction, including youths. The glasses may feature interchangeable lenses to accommodate different situations. Exact size, measurement, construction, and design specifications may vary upon further development and manufacturing.

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claim.

In the foregoing description, numerous details are set forth. It will be apparent, however, to one of ordinary skill in the art having the benefit of this disclosure, that the present invention can be practiced without these specific details.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention can be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Present Disclosure

The present disclosure provides an eyewear apparatus capable of allowing a wearer to provide useful information to a hairdresser.

The present disclosure provides a simple and cost effective an eyewear apparatus capable of allowing a wearer to provide useful information to a hairdresser.

The present disclosure provides a reliable, efficient, and accurate an eyewear apparatus capable of allowing a wearer to provide useful information to a hairdresser.

The present disclosure provides a robust eyewear apparatus capable of allowing a wearer to provide useful information to a hairdresser.

We claim:

1. An eyewear apparatus (100) capable of allowing a wearer to provide useful information to a hairdresser, the apparatus (100) comprising:
at least one visual device (110) configured to provide vision to the wearer; and
wherein, during operation, the apparatus (100) is configured to be disposed on the wearer such that the disposal of the apparatus (100) causes no hindrance to the hairdresser's work functions.

2. The apparatus (100) as claimed in claim 1, wherein the apparatus (100) causes no hindrance to the hairdresser, by means of having no support arms that are capable of providing hindrance on the person of the wearer where the hairdresser is conducts given work functions, during operation.

3. The apparatus (100) as claimed in claim 2, wherein the apparatus (100) includes a maximum of two visual devices, the first visual device (110), and a second visual device (120).

4. The apparatus (100) according to claim 3, wherein the apparatus (100) further comprises a nose bridge (130) that connects the first visual device (110) and a second visual device (120), and a nose pad assembly (140) configured to provide a placement mechanism for the apparatus.

5. The apparatus (100) as claimed in claim 4, wherein the visual devices (110, 120) include lenses or glasses or other mechanism directed towards near-sightedness, or far-sightedness.

6. The apparatus (100) according to claim 5, wherein the apparatus (100) is unisex.

7. The apparatus (100) according to claim 5, wherein the apparatus (100) is of a universal size construction.
